(19) United States
(12) Patent Application Publication
(10) Pub. No.: US 2015/0337987 A1
(43) Pub. Date: Nov. 26, 2015

(54) Method and Structure for in situ Field Repair of Severed Drain Tile

(71) Applicant: HAMMAN IP LLC, Mt. Sterling, OH (US)

(72) Inventor: Carl R. Hamman, Mt. Sterling, OH (US)

(73) Assignee: HAMMAN IP LLC, Mt. Sterling, OH (US)

(21) Appl. No.: 14/701,916

(22) Filed: May 1, 2015

Related U.S. Application Data
(63) Continuation-in-part of application No. 14/285,674, filed on May 23, 2014, now Pat. No. 8,939,680.

(51) Int. Cl. F16L 1/11; F16L 3/00; F16L 55/18; F16L 1/036

(52) U.S. Cl. CPC F16L 1/11; F16L 1/036; F16L 3/00; F16L 55/18

(57) ABSTRACT

Disclosed is a structure for repairing drain tile or any other conduit found in the construction of underground utilities, which conduit severed by the digging of a ditch. A spray-in-place or pre-manufactured a foamed polymer bridge is placed transverse to the longitudinal direction of the underground utility conduit and atop the underground utility conduit. The foamed polymer bridge has a cavity at its top and is semi-circular at its bottom for fitting over the underground utility conduit. Weight is placed in the polymeric foam cavity for countering water buoyancy forces on the polymer foam in the ditch when the ditch is back-filled with dirt. Additionally, such pre-manufactured foam bridges can be used as breakers to support underground utilities, such as large pipe.

### CROSS-REFERENCE TO RELATED APPLICATIONS

This application is a continuation-in-part of application Ser. No. 14/285,674, filed on May 23, 2014, which claims benefit of provisional application 61/826,518.

### STATEMENT REGARDING FEDERALLY SPONSORED RESEARCH

Not applicable.

### BACKGROUND

The present disclosure generally relates to repair of conduit in the field (in situ) and more particularly to repair of drain tile cut during the laying of utilities, such as, inter alia, large diameter gas pipe.

Large diameter gas pipeline, for example, is laid in ditches, usually over large distances. This also is true of other utilities. It would be uneconomic to circumvent each and every drain tile or drainage pipe encountered. Thus, the gas pipeline contractor during excavation of the ditch cuts the drain tiles encountered in order to save time and money. A crew, then, goes back and repairs each cut drain tile in the field.

Commonly owned U.S. Pat. No 8,939,680 discloses a spray-in-place or pre-formed polymer foam bridge overlaying the pipeline with weight (sandbags) placed on the foam bridge to counter buoyancy, and a support for the repaired drain tile laid atop the sandbag weight. For larger diameter drain tile or where best practices are not required, the support may not be needed.

### BRIEF SUMMARY

Disclosed is a structure for repairing drain tile or any other conduit found in the construction of underground utilities, which conduit was severed by the digging of a ditch for the underground utility. A spray-in-place or pre-manufactured foamed polymer bridge is placed transverse to the longitudinal direction of the underground utility conduit and atop the underground utility pipe. The foamed polymer bridge has a cavity at its top and is semi-circular at its bottom for fitting over the underground utility conduit. Weight is placed in the polymeric foam cavity for countering water buoyancy forces on the polymer foam in the ditch after the ditch is back-filled with dirt.

Additionally, such pre-manufactured foam bridges can be used as breakers to support underground utilities, such as large pipe. Final height and/or slope can be achieved by use of polymeric spray foam or shims. Much cost savings and time can be realized by use of pre-manufactured breakers, foam shims, and/or polymeric foam spray.

### BRIEF DESCRIPTION OF THE DRAWINGS

For a fuller understanding of the nature and advantages of the present media and process, reference should be had to the following detailed description taken in connection with the accompanying drawings, in which:

FIG. 1 is an isometric view of a large utility laid in a ditch in a field;

FIG. 2 is a top view of a drain tile repair structure, as disclosed herein;

FIG. 3 is a side view of the drain tile repair structure of FIG. 2;

FIG. 4 is an end view of the drain tile repair structure of FIG. 2;

FIG. 5 is an isometric view of a top section of an additional embodiment foam breaker;

FIG. 6 is an isometric view of the bottom section of the additional embodiment foam breaker;

FIG. 7 is a sectional view like that in FIG. 4 employing the foam breaker components of FIGS. 5 and 6;

FIG. 8 is an isometric view of the FIG. 5 embodiment made from 2 different foams;

FIG. 9 is an alternative embodiment to that shown in FIG. 8; and

FIG. 10 is sectional view of the FIG. 9 embodiment also showing the drain tile being supported.

These drawings will be further described below.

### DETAILED DESCRIPTION

While the instant description relates to a gas pipe ditch wherein a drain tile has been severed while digging the ditch for the gas pipe, such description merely is for illustrating the precepts of the present disclosure, which in its broadest precepts relates to a conduit severed while digging a ditch.

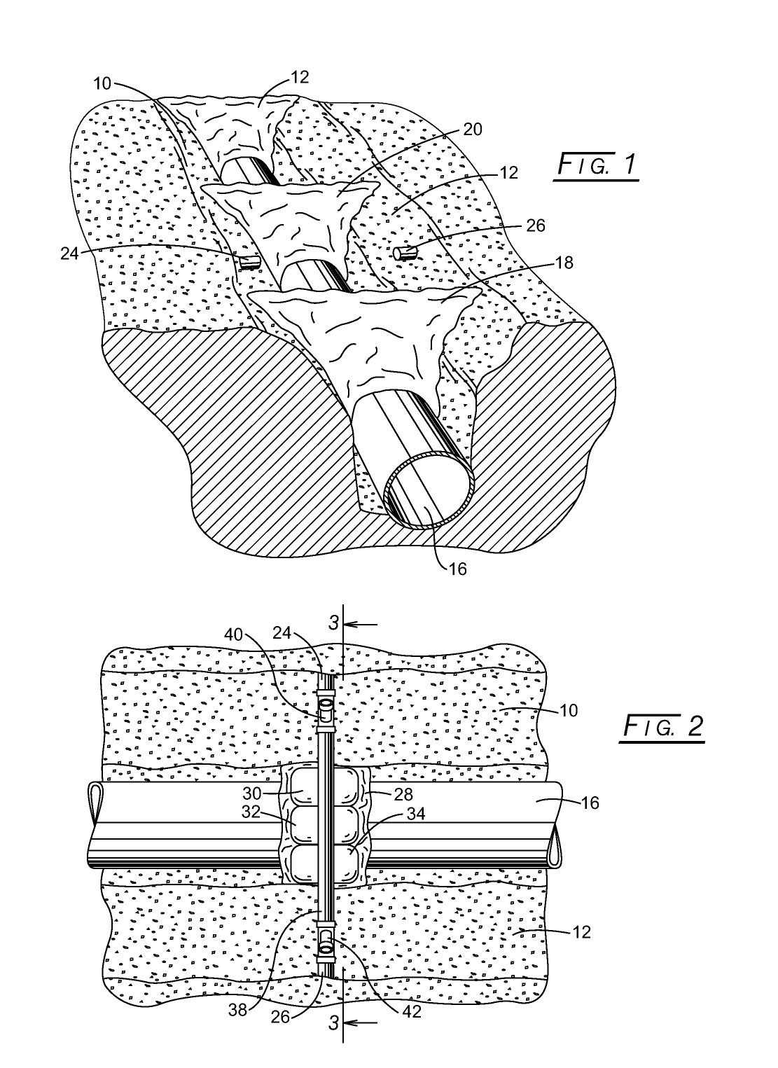

Referring initially to FIG. 1, a ditch is seen formed by a pair of sides, 10 and 12. Inside the ditch is a utility, 16, such as a natural gas pipeline. In order to support pipeline 16, such as, for example, a gas pipeline, a pier or base (not seen) of, for example, polyurethane (or other suitable material) foam is sprayed in the ditch for support of pipeline 16. Such foam sets very rapidly. Pipeline 16 is placed atop such foam piers (not shown in the drawings). Foam breakers, 18, 20, and 22, are spayed in place atop pipeline 16 for stopping free flow of water in the ditch. While a spray-in-place foam bridge often is used both beneath pipeline 16 and atop pipeline 16, it will be appreciated that preformed breakers and/or piers can be used to advantage for support of pipeline 16 and bridges 18, 20, and 22. Breakers normally are used only on sloping terrain, as earth typically will support pipeline 16 on level ground. Between adjacent foam breakers 18 and 10 are ends, 24 and 26, of drain tile severed during the digging of the ditch. It is not typical to encounter drain tile on very sloping ground. FIG. 1, then, is for illustration purposes of severed drain tile as well as the use of breakers to support pipeline on inclined terrain.

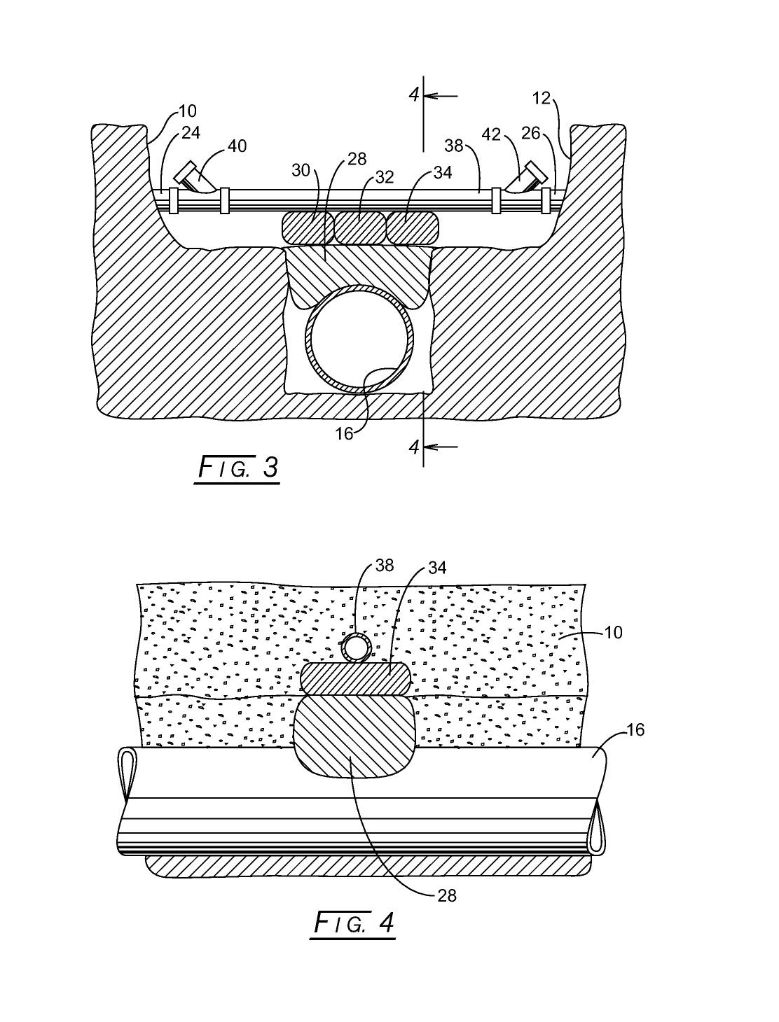

The structure for bridging the ditch for repair of the severed drain tile ends, 24 and 26 is illustrated in FIGS. 2-4. Referring to these drawings, a pre-formed bridge, 28, is placed in the ditch atop the gas pipeline at the severed drain tile location. Such foam bridge not only will support the new drain tile section joining ends 24 and 26, but it also supports the sides 10 and 12 of the ditch to help prevent cave-ins. Sandbags, 30, 32, and 34, are placed atop bridge 28 so as to match the slope of a pipe that will span between severed drain tile ends 24 and 26.

It should be recognized that use of polymeric foam spray, polymeric shims, or other techniques might be used in place of the sandbags in order to achieve any desired slope.

The new drain tile section, 38, then, is placed across the ditch. Note that drain tile section 38 has a pair of slanted inspection ports, 40 and 42, on either end. A camera can be inserted into either port 40 and 42 for inspection purposes, such as, for example, to ensure that drain tile section 38 was properly installed, and mated with ends 24 and 26.

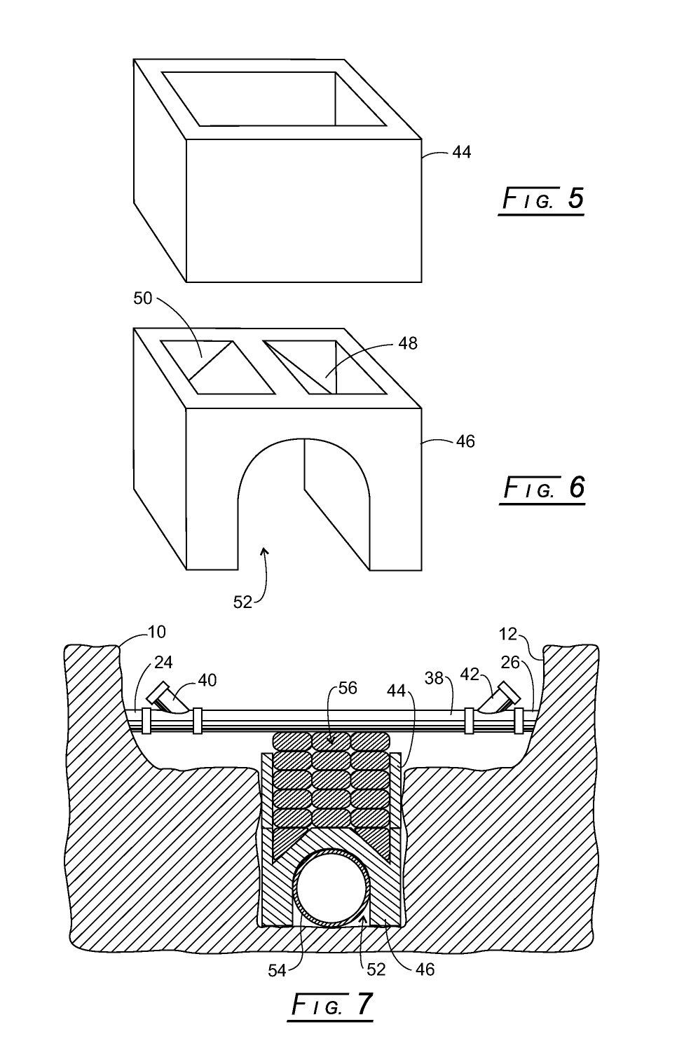

Referring to FIGS. 5 and 6, a rectangular annular top component, 44, that sits atop lower foam bridge component, 46. Lower foam bridge component 46 has a pair of opposing triangular cutouts, 48 and 50, into which a sand bag or other ballast can be placed. A lower semi-circular cutout, 52, fits atop a pipe, 54, (see FIG. 7) disposed within the ditch. Foam pieces 44 and 46 can be secured by adhesive in the field. Duct tape or similar tape can be used to additionally secure foam pieces 44 and 46 together.

It should be observed that with proper dimensioning, a total of 17 sandbags could fill the inner space of foam pieces 44 and 46. The weight of that number of sandbags counters the upward forces of water in the ditch that tend to cause the foam bridge to rise and press against new drain tile section 38. There must be about 60 pounds of weight capacity in the cavities per cubic foot of foam in order to overcome water buoyancy forces on the foam bridge.

Referring to FIG. 7, an array of sandbags, 56, are seen housed within cavity formed by the combination of foam bridge components 44 and 46. The remaining items in FIG. 7 have been numbered as they are in FIG. 4 whereat their description can be found.

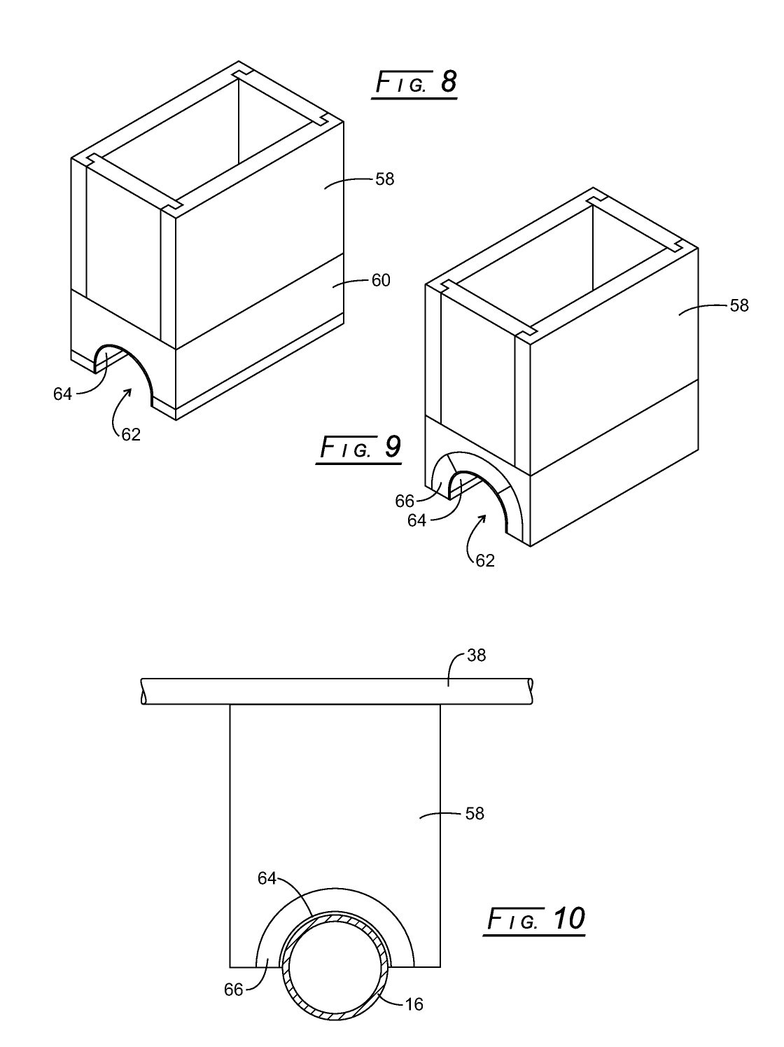

Referring to FIG. 8, a rectangular empty upper box, 58, made of one type of foam (e.g., expanded polystyrene) sits atop a lower rectangular box, 60, made of a second type of foam (e.g., expanded polypropylene) and having a lower semi-circular cut-out, 62, for hugging the pipe or drain tile. The composition of the lower section may aid in providing cathodic protection. A liner, 64, lines cut-out 62 to protect the pipeline and can be made from a variety of rubberized materials, such as, for example, expanded high density polyethylene (HDPE) exhibiting compressive strength and flexibility and extruded into a diamond mesh pattern (Denso Rock Shield HD, Denso North America, Houston, Tex.).

FIG. 9 shows an alternative embodiment to that shown in FIG. 9, where a semi-circular second foam liner, 66, (e.g., 4 inches of polypropylene) is used instead of the lower rectangular box, 60. Alternative designs to those of FIGS. 8 and 9 may be envisioned.

An additional use of pre-formed foam structures is as a foam breaker and a pier. Cut to standard width and length with variable height (or some other standards), a crew can take a few sizes from the factor and place them in the ditch as breakers (water dams) rather than to create such breakers with polymeric foam spray. Cost and labor savings can be achieve with pre-formed breakers. As described above, small cans of spray polymeric foam and/or polymeric foam shims can be used as is necessary, desirable, and/or convenient to achieve a desired slope, ensure full contact of the pre-formed breaker with the pipeline, or the like.

While the method and structure has been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. In this application all units are in the US Engineering system and all amounts and percentages are by weight, unless otherwise expressly indicated. Also, all citations referred herein are expressly incorporated herein by reference.

I claim:

1. A structure for supporting repaired conduit severed in the construction of an underground utility, which conduit was severed by the digging of a utility ditch, said structure comprising:
a polymer foam bridge placed transverse to the longitudinal direction of the underground utility and placed atop the underground utility, the polymer foam bridge having a cavity at its top and semi-circular at its bottom; and
weight placed in the polymer foam bridge cavity for countering buoyancy forces in the ditch after back-filled with dirt.

2. The structure of claim 1, used in underground utility pipe.

3. The structure of claim 1, wherein the weight comprising sandbags.

4. The structure of claim 1, wherein the conduit comprises a pipe.

5. The structure of claim 1, wherein the polymer foam bridge is made from one or more of foamed polyethylene, foamed polypropylene, or foamed polystyrene.

6. The structure of claim 1, wherein the polymer foam bridge comprises a pre-made foam bridge.

7. A method for supporting repaired conduit severed in the construction of an underground utility, which conduit was severed by the digging of a utility ditch, which comprises the steps of:
(a) placing a polymer foam bridge over the underground utility transverse to the longitudinal direction of the underground utility and placed atop the underground utility, the polymer foam bridge having a cavity at its top and semi-circular at its bottom; and
(b) placing weight placed in the polymer foam bridge cavity for countering buoyancy forces in the ditch when back-filled with dirt.

8. The method of claim 7, wherein the underground utility comprises underground utility pipeline.

9. The method of claim 7, wherein the weight comprising sandbags.

10. The method of claim 7, wherein the polymer foam bridge is made from one or more of foamed polyethylene, foamed polypropylene, or foamed polystyrene.

11. The method of claim 7, which additionally comprises the steps of:
(d) repairing the severed conduit; and
(e) providing inspection ports slanting away from the underground utility in the repaired conduit for later remote inspection should the repaired pipe become clogged.

12. The method of claim 7, wherein the conduit comprises a pipe.

13. The method of claim 7, wherein the severed pipe comprises severed drain tile.

14. The method of claim 7, wherein a liner lines the foamed bridge semi-circular bottom.

15. The method of claim 14, wherein the liner is a rubberized material.

16. The method of claim 15, wherein fiberglass is located between the rubberized material and the polymer foam bridge semi-circular bottom.

17. The method of claim 7, further comprising placing a liner between the polymer foam bridge semi-circular bottom and the underground utility.

18. The method of claim 17, wherein the liner is formed from a rubberized material.

19. The method of claim 18, wherein fiberglass is placed between the rubberized material and the polymer foam bridge semi-circular bottom.

20. The method of claim 7, wherein the polymer foam bridge comprises a pre-made foam bridge.
